(19) United States
(12) Patent Application Publication
(10) Pub. No.: US 2013/0171453 A1
(43) Pub. Date: Jul. 4, 2013

(54) Graphite Electrodes

(71) Applicants: Kevin Patrick Fenton, North Olmsted, OH (US); Aaron Tomasek, Lodi, OH (US); Andrew Justin Francis, Cleveland, OH (US)

(72) Inventors: Kevin Patrick Fenton, North Olmsted, OH (US); Aaron Tomasek, Lodi, OH (US); Andrew Justin Francis, Cleveland, OH (US)

(73) Assignee: GRAFTECH INTERNATIONAL HOLDINGS INC., Parma, OH (US)

(21) Appl. No.: 13/704,280

(22) PCT Filed: Jun. 29, 2011
(86) PCT No.: PCT/US11/42401

§ 371 Date: Mar. 19, 2013

Related U.S. Application Data
(60) Provisional application No. 61/360,844, filed on Jul. 1, 2010.

(51) Int. Cl. B32B 9/00; C01B 31/02

(52) U.S. Cl. CPC B32B 9/007; C01B 31/02
USPC 428/408; 264/29.1

(57) ABSTRACT

A carbon article having a first zone and a second zone wherein in the first zone formed from a first mix design and the second zone formed from a second mix design and the first and second mix designs have at least one difference selected from the group of differences of a presence of a certain material, a concentration of a certain material, the size of the a certain material and combinations thereof.

### BACKGROUND

1. Technical Field

The present disclosure relates to a graphite electrode, exhibiting improved properties by providing zones of differing characteristics, and a process for preparing the described graphite electrode. More particularly, the disclosure concerns a graphite electrode having one or more zones which differ measurably from other zones of the electrode in terms of strength, electrical characteristics, composition, etc.

2. Background Art

Graphite electrodes are used in the steel industry to melt metals and other ingredients used to form steel in electrothermal furnaces. The heat needed to melt metals is generated by passing current through a plurality of electrodes, usually three, and forming an arc between the electrodes and the metal. Electrical currents in excess of 100,000 amperes are often used. The resulting high temperature melts the metals and other ingredients. Generally, the electrodes used in steel furnaces are present in the form of electrode columns, which is a series of individual electrodes joined to form a single column. In this way, as electrodes are depleted during the thermal process, replacement electrodes can be joined to the column to maintain the length of the column extending into the furnace.

Generally, electrodes are joined into columns via a pin (sometimes referred to as a nipple) that functions to join the ends of adjoining electrodes. Typically, the pin takes the form of opposed male threaded sections, with at least one end of the electrodes comprising female threaded sections capable of mating with the male threaded section of the pin. Thus, when each of the opposing male threaded sections of a pin are threaded into female threaded sections in the ends of two electrodes, those electrodes become joined into an electrode column. Commonly, the joined ends of the adjoining electrodes, and the pin therebetween, are referred to in the art as a joint (or, more specifically, a pin joint).

Alternatively, the electrodes can be formed with a threaded protrusion or tang machined into one end and a threaded socket machined into the other end, such that the electrodes can be joined by threading the tang of one electrode into the socket of a second electrode, and thus form an electrode column. The joined ends of two adjoining electrodes in such an embodiment is also referred to in the art as a pinless joint. In the production of an embodiment of a pinless electrode, the threads of the joint may include so-called “blocked” threads, also referred to in the industry as “fully jammed” threads, which are often employed. In blocked threads, both thread flanks from one of the elements (such as the male tang) is in contact with both thread flanks from the other element (such as the female socket). Contrariwise, in “non-blocked” or “unblocked” threads, referred to in the industry as “jammed” or “partially-jammed” threads, only one thread flank from each element contacts the threads of the other element, and are commonly employed in pin joints.

Given the extreme thermal stress that the electrode and the joint (and indeed the electrode column as a whole) undergo, mechanical/thermal factors such as strength, thermal expansion, and crack resistance must be carefully balanced to avoid damage or destruction of the electrode column or individual electrodes. For instance, longitudinal (i.e., along the length of the electrode/electrode column) thermal expansion of the electrodes, especially at a rate different than that of the pin, can force the joint apart, reducing effectiveness of the electrode column in conducting the electrical current. A certain amount of transverse (i.e., across the diameter of the electrode/electrode column) thermal expansion of the electrode in excess of that of the pin may be desirable to form a firm connection between the pin and the electrode; however, if the transverse thermal expansion of the electrode greatly exceeds that of the pin, damage to the electrode or separation of the joint may result. Again, this can result in reduced effectiveness of the electrode column, or even destruction of the column if the damage is so severe that the electrode column fails at the joint section.

Moreover, another effect of the thermal and mechanical stresses to which an electrode column is exposed is literal unscrewing of the electrodes forming the joint (or the electrodes and pins forming the joint), due to vibrations and other stresses. This unscrewing can reduce electrode column efficiency by reducing electrical contact between adjoining electrodes. In the most severe case, unscrewing can result in loss of the electrode column below the affected joint.

What is desired, therefore, is a graphite electrode better able to withstand the thermal and mechanical stresses to which it will be exposed in an electric arc furnace, as compared to art-conventional graphite electrodes. It is also highly desirable to achieve these benefits while maintaining the commercial practicality of manufacture of the subject graphite electrodes.

### BRIEF DESCRIPTION OF THE DISCLOSURE

It is an aspect of the present disclosure to provide a graphite electrode having distinct zones, with at least one zone having a measurable difference when compared with other zones of the same electrode.

It is another aspect of the present disclosure to provide a graphite electrode having at least one zone having a measurable difference when compared with other zones of the same electrode, where such at least one zone is located at a terminal portion of the graphite electrode.

It is another aspect of the present disclosure to provide a graphite electrode having at least one zone having a measurable difference when compared with other zones of the same electrode, where such at least one zone is located at an exterior portion of the graphite electrode.

Still another aspect of the present disclosure is a graphite electrode having at least one zone having a measurable difference when compared with other zones of the same electrode, where such measurable difference constitutes the level of fibers in such at least one zone.

These aspects and others that will become apparent to the artisan upon review of the following description can be accomplished by providing a carbon article having a first zone and a second zone wherein in the first zone formed from a first mix design and the second zone formed from a second mix design and the first and second mix designs have at least one difference selected from the group of differences of a presence of a certain material, a concentration of a certain material, the size of a certain material and combinations thereof. In some embodiments, the disclosure includes a carbon article having a first zone and a second zone, the first zone having a concentration of carbon fibers greater than a concentration of carbons fibers in the second zone and wherein the first zone comprises at least one of an exterior portion or a terminal portion of the article, advantageously where the concentration of carbon fibers in the second zone comprises at least about 20% less than the concentration of carbon fibers in the first zone. A third zone can optionally be included, where the third zone may be located opposed to the first zone and constructed from substantially the same mix design as the first mix design.

Also included in the present disclosure is a method of making a carbon article, such as those described hereinabove, the mixture including combining a first mix design and a second mix design in a segregated manner, wherein the first mix design differs from the second mix design in at least one manner; forming a green article and carbonizing the green article. The forming can include at least one of co-extrusion or hot pressing; if hot pressing, the combining comprises installing a separator in a mold and removing the separator prior to an application of pressure.

### DETAILED DESCRIPTION OF THE PREFERRED EMBODIMENT

In certain embodiments, graphite electrodes are fabricated by first combining a particulate fraction comprising calcined coke, pitch and, optionally, carbon fibers into a stock blend. Mesosphase pitch or PAN based carbon fibers are two examples of suitable types of carbon fibers. The disclosure herein is not limited to the above types of carbon fibers. Other types of fibers such as cotton, rayon, or biomass derived carbon fibers may be used. Additionally the carbon fibers may or may not be graphitized. More specifically, crushed, sized and milled calcined petroleum coke is mixed with a coal-tar pitch binder to form the blend. Generally, in graphite electrodes for use in processing steel, particles up to about 25 millimeters (mm) in average diameter are employed in the blend. The particulate fraction preferable includes a small particle size filler comprising coke powder. Other additives that may be incorporated into the small particle size filler include iron oxides to inhibit puffing (caused by release of sulfur from its bond with carbon inside the coke particles), coke powder and oils or other lubricants to facilitate extrusion of the blend.

After the blend of particulate fraction, pitch binder, etc., the body is formed (or shaped) by extrusion though a die or molded in forming molds to form what is referred to as a green stock. The forming, whether through extrusion or molding, is conducted at a temperature close to the softening point of the pitch, usually about 100° C. or higher. The die or mold can form the article in substantially final form and size, although machining of the finished article is usually needed, at the very least to provide structure such as threads. The size of the green stock can vary; for electrodes the diameter can vary between about 220 mm and 800 mm.

After extrusion, the green stock is heat treated by baking at a temperature of between about 700° C. and about 1100° C., more preferably between about 800° C. and about 1000° C., to carbonize the pitch binder to solid pitch coke, to give the article permanency of form, high mechanical strength, good thermal conductivity, and comparatively low electrical resistance, and thus form a carbonized stock. The green stock is baked in the relative absence of air to avoid oxidation. Baking should be carried out at a rate of about 1° C. to about 5° C. rise per hour to the final temperature. After baking, the carbonized stock may be impregnated one or more times with coal tar or petroleum pitch, or other types of pitches or resins known in the industry, to deposit additional coke in any open pores of the stock. Each impregnation is then followed by an additional baking step.

After baking, the carbonized stock is then graphitized. Graphitization is by heat treatment at a final temperature of between about 2500° C. to about 3400° C. for a time sufficient to cause the carbon atoms in the coke and pitch coke binder to transform from a poorly ordered state into the crystalline structure of graphite. Advantageously, graphitization is performed by maintaining the carbonized stock at a temperature of at least about 2700° C., and more advantageously at a temperature of between about 2700° C. and about 3200° C. At these high temperatures, elements other than carbon are volatilized and escape as vapors. The time required for maintenance at the graphitization temperature using the process of the present disclosure is no more than about 18 hours, indeed, no more than about 12 hours. Preferably, graphitization is for about 1.5 to about 8 hours. Once graphitization is completed, the finished article can be cut to size and then machined or otherwise formed into its final configuration.

In an alternative embodiment, formation of a graphite electrode can be accomplished by use of resistance heating of the blend of particulate fraction, pitch binder, etc. in a hot pressing step. During the hot pressing step, resistance heating is accompanied by application of mechanical pressure (“hot-pressing”) to increase the density and carbonization of the blend. Optionally, after hot-pressing, the preform electrode or pin may be subjected to one or more densification steps employing a carbonizable pitch to further increase the density of the preform prior to the graphitization step.

During the hot pressing stage, the hot press stock mixture or blend is hot pressed to create a preform body, such as a preform electrode or pin. In the hot pressing process, the hot press mixture is heated to a sufficient temperature to melt at least a portion of the stock material. This heating step includes applying an electric current to the hot press mixture such that heat is generated within the mixture. While heating the hot press mixture, a pressure is applied to the mixture to form a preform electrode or pin that is at least partially carbonized.

In one embodiment, a hydraulic hot press assembly suited to resistively heat and hydraulic compress a hot press mixture (i.e. the dry mixed stock or, optionally, the heat softened stock or the green electrode or pin) is employed to manufacture a preform carbon body, such as a preform electrode or pin. One exemplary hydraulic hot press assembly includes a hydraulic press having an integrally attached hot press mold, the mold having a cavity shaped to receive the hot press mixture and form the desired preform. Preferably, the hot press mold is shaped to the approximate dimensions of the desired graphitized carbon body, such as a graphite pin or electrode. Additionally, the hot press mold is preferably contained within a thermally insulated housing. Pressure is applied to the hot press mixture by hydraulic pistons, and is preferably applied so as to achieve a uniform pressure along the mixture. The application of pressure is also preferably in a molding direction perpendicular to the longitudinal axis of the preform so as to obtain a longitudinally preferred carbon body, i.e. having a crystalline structure oriented so as to provide the greatest tensile strength along the longitudinal axis of the body. In a preferred configuration, the hot press mold will be oriented so as to mold the preform with its longitudinal axis in a horizontal plane. Pressure is then applied to the hot press mixture by upper and/or lower vertical hydraulic pistons operating in single or double action.

In a preferred embodiment, the ends of the hot press molds are stainless steel end plates, which are in electrical contact with the hot press mixture. A resistive heating system applies an electrical current to the hot press mixture through these end plates. In a more preferred embodiment, the pistons and the hot press mold each have a silicon carbide surface liner and are both electrically insulated from the frame of the hydraulic hot press assembly. The resistive heating system includes a source of electrical power for providing a high current at low voltage, such as a DC supply. High AC currents are also contemplated. The DC or AC supply is electrically connected with the stainless steel end plates. The construction of the hydraulic hot press assembly is such that all parts of the hot press mixture within the hot press mold cavity are subjected to a substantially uniform current flow. Resistively heating and compressively molding the hot press mixture under current and pressure conditions that are generally uniform throughout the hot press mixture results in substantially uniform characteristics throughout the preform electrode or pin and further results in a significant reduction in fissures and other irregularities, which tend to result in fracture during use. Preferably, a programmed application of the current and pressure provides, among other things, hot press mixture temperatures, pressures, heating rates and pressurization rates in accordance with a desired baking process, the calculations of which are based upon specific stock kinetics. More preferably, a programmable control system integral to the hydraulic hot press assembly provides such a programmed application of current and pressure.

After carbonization during the hot pressing operation, the carbonized stock is then graphitized, as discussed hereinabove. Again, graphitization is by heat treatment at a final temperature of between about 2500° C. to about 3400° C. for a time sufficient to cause the carbon atoms in the coke and pitch coke binder to transform from a poorly ordered state into the crystalline structure of graphite. Advantageously, graphitization is performed by maintaining the carbonized stock at a temperature of at least about 2700° C., and more advantageously at a temperature of between about 2700° C. and about 3200° C.

In an embodiment of the present disclosure, the graphite article, whether a graphite electrode, a pin for graphite electrodes or a graphite billet, has a plurality of zones, where at least one zone is measurably distinct from at least one other zone. By zone is meant an area or portion of the graphite electrode, pin, or billet. By measurably distinct it is meant that the difference for the at least one characteristic is measurably different in the first zone as compared to the second zone of the end article. By way of example only, in terms of concentration of a material, this can mean that the concentration of a certain material may differ from the first zone to the second zone by at least about 20%, preferably at least about 25%, and more preferably at least about 50%. In certain preferred embodiments, this is accomplished by different mix designs, that is, combinations of different stock mixtures or blends, as described in more detail hereinbelow.

For instance, in certain embodiments, at least one zone of the graphite electrode or pin can include fibers, to improve the strength of the electrode or pin in high stress regions. In some embodiments, the fibers are mesophase pitch-based carbon fibers or fibers derived from PAN (polyacrylonitrile). The fibers used should advantageously have a Young's modulus (after carbonization) of about 15×10⁶ psi to about 40×10⁶ psi. They preferably have an average diameter of about 6 to about 15 microns, a tensile strength of about 200×10³ psi to about 400×10³ psi, and are preferably about 4 mm to about 32 mm in length on average. Suitable lengths of fiber include an average length of about 6 mm or less, about 12 mm or less, about 18 mm or less, or about 25 mm or less. It is also preferred that the carbon fibers are not longer than the biggest coke particle. Most advantageously, the fibers are added to the blend as bundles containing between about 2000 and about 20,000 fibers per bundle, compacted with the use of a sizing.

The carbon fibers are preferably included in one of the zones of the graphite electrode or pin at a level of about 1% to about 10% by weight, more preferably about 1.5% to up to about 7.5%, even more preferably, about 5.0% or less. However, in other zones of the graphite electrode, pin or article, fibers are present at levels at least about 20% less, or even about 25% less, or even more preferred about 50% less; as such, the zone(s) having fibers constitute distinct zone(s) in the electrode or pin. Indeed, in certain embodiments, at least one other zone has no fibers and, therefore, is a distinct zone as compared to a zone having 1% by weight fibers or more. By way of example in terms of an electrode, in a first zone of the electrode, e.g., a first socket area of the electrode, the concentration of fibers may be about 10%. In a second zone of the electrode, e.g., a central portion of the electrode, the concentration of fibers in the second zone is no more than about 8.0%. This embodiment may include an optional third zone of the electrode wherein the concentration of fibers is substantially the same as the first zone. In this embodiment the third zone may include a second socket area located opposed to the first socket area.

In a further certain embodiment, the electrode may include one or more segments which are substantially devoid of carbon fibers; meaning have an insufficient amount of fibers to affect the desired property of the electrode. Even more preferred, the electrode segment may be completely devoid of carbon fibers. The above embodiments may be practiced in any combination thereof.

It has been recognized that the inclusion of fibers in graphite electrodes or pins can improve the strength of a graphite electrode or pin (see, for instance, Kortovich et al., in International Publication No. WO 2004/020185, Singer, in U.S. Pat. No. 4,005,183, and Shao et al., in U.S. Pat. No. 6,280,663, the disclosure of each of which are incorporated herein by reference in their entirety). However, it has also been recognized that the inclusion of fibers in graphite electrodes or pins in significant enough levels is cost prohibitive. By enabling the inclusion of fibers in only those areas of the graphite electrode or pin which are high stress regions, such as the thread regions, the advantages of the inclusion of fibers can be obtained with lower cost implications, thus retaining the commercial feasibility of the article.

In other embodiments, one zone of the graphite article can include sulfur to inhibit puffing, while other zones do not. For example, it would be useful to include sulfur in those zones of a graphite electrode or pin which include the thread regions, but disadvantageous to include sulfur in the interior of a pin or electrode, where it can lead to splitting. The practice of the present disclosure can be used to “engineer” a graphite electrode or pin such that sulfur is preferentially contained in a zone including the thread regions but not a zone constituting the interior portion of the article. Likewise, in still other embodiments, advantages can be obtained through the control of coke particle size in certain zones vis-à-vis others, or in the presence of iron oxide in certain zones vis-à-vis others. Again, this can be accomplished using the present disclosure.

In one embodiment, especially useful when the body is formed (or shaped) by extrusion of the stock blend though a die, as described above, the distinct zones are formed by a co-extrusion process. In co-extrusion, distinct stock blends, such as a first stock blend containing at least 1% fibers by weight and a second stock blend containing at least 25% less fibers by weight are each extruded through adjacent extrusion pipes, and then meet to form a single article. In this way, two distinct zones are formed in the article, for example, a first zone may include at least 1% fibers by weight and a second zone may includes at least about 25% less fibers by weight than that of the first zone. In another embodiment the difference in the amount of fibers is at least about 50%; in a further embodiment the difference is at least about 75%. The extrusion pipes can be situated in various arrangements, depending on how the user wishes to array the distinct zones. For example, in the case of fibers, it may be desirable to have a zone of increased fiber level (sometimes referred to as fiber loading) in an external portion of the graphite electrode or pin for improved strength, but less desirable to have a zone of increased fiber loading in an internal portion or core of the graphite electrode or pin for cost reasons. In this circumstance, the article can be formed by co-extrusion, where two extrusion pipes are arranged co-axially, one about the other.

In a co-extrusion embodiment for a producing an electrode having increased fiber loading in an external portion as compared to the core of the electrode, a first stock blend is prepared having at least 1% by weight fiber and extruded through the outer extrusion pipe of a co-extrusion apparatus, and a second stock blend prepared having at least 25% lower fiber loading (or, more preferably no fibers) and extruded through the central extrusion pipe of the extrusion apparatus. In this manner, the extruded body has a distinct zone of higher fibers in the outer portion and a distinct zone of lower (or no) fibers in the core or internal zone.

In another embodiment, especially useful when the body is formed (or shaped) by hot pressing, a plurality of hot press stock mixtures are fed into the mold, each forming a distinct zone in the final body. For instance, in the case of fiber loading, a first hot press stock blend is prepared having at least 1% by weight fiber, and a second hot press stock blend is prepared having at least 25% lower fiber loading, or no fibers at all. These two hot press stock blends can then be fed into the hot press mold in a specific order, specific locations, and/or amounts to create the desired zones. As an example, it may be desirable to have higher fiber loading in the areas of a graphite electrode or pins where there are threads, i.e., the terminal positions or ends of the article because they are high stress areas where greater strength is desirable. In this situation, a hot press stock blend having at least 1% by weight fiber is fed first into the mold to form a first terminal portion of the article; hot press stock blend having at least 25% lower fiber loading, or no fibers at all, is fed next into the mold to form the central portion of the article; a hot press stock blend having at least 1% by weight fiber is fed next into the mold to form a second terminal portion of the article. In some embodiments, a separator can be placed between the zones in the mold prior to the application of heat and pressure, and then removed to form a unitary article when heat and pressure is applied.

In this manner, a cost effective carbon article, such as a graphite electrode or pin, can be prepared, having distinct regions or zones having characteristics different from other regions or zones, in order to provide an article better able to withstand the thermal and mechanical stresses to which it will be exposed in, e.g., an electric arc furnace, as compared to art-conventional articles, while maintaining the commercial practicality of manufacture of the subject graphite electrodes

The disclosures of all cited patents and publications referred to in this application are incorporated herein by reference in their entirety. The above percentages regarding concentration are percent by weight if not specifically stated otherwise.

The above description is intended to enable the person skilled in the art to practice the disclosure. It is not intended to detail all of the possible variations and modifications that will become apparent to the skilled worker upon reading the description. It is intended, however, that all such modifications and variations be included within the scope of the disclosure that is defined by the following claims. The claims are intended to cover the indicated elements and steps in any arrangement or sequence that is effective to meet the objectives intended for the disclosure, unless the context specifically indicates the contrary.

What is claimed is:

1. A carbon article having a first zone and a second zone, the first zone having a concentration of carbon fibers greater than a concentration of carbon fibers in the second zone and wherein the first zone comprises at least one of an exterior portion or a terminal portion of the article.

2. The article of claim 1 wherein the first zone comprises a terminal portion of the article.

3. The article of claim 1 wherein the first zone comprises the exterior portion of the article.

4. The article of claim 1 wherein the concentration of carbon fibers in the second zone comprises at least about 20% less than the concentration of carbon fibers in the first zone.

5. A carbon article having a first zone and a second zone wherein in the first zone formed from a first mix design and the second zone formed from a second mix design and the first and second mix designs have at least one difference selected from the group of differences of a presence of a certain material, a concentration of a certain material, the size of a certain material and combinations thereof.

6. The article of claim 5 wherein the difference comprises at least a concentration of carbon fibers in the first mix design as compared to a concentration of carbon fibers included in the second mix design.

7. The article of claim 5 wherein the first zone comprises an exterior portion of the article.

8. The article of claim 5 wherein the first zone comprises a terminal portion of the article.

9. The article of claim 8 further comprising a third zone wherein the third zone located opposed to the first zone and constructed from substantially the same mix design as the first mix design.

10. A method of making a carbon article comprising
a. combining a first mix design and a second mix design in a segregated manner, wherein the first mix design differs from the second mix design in at least one manner;
b. forming a green article; and
c. carbonizing the green article.

11. The method of claim 10 wherein the forming comprises at least one of co-extrusion or hot pressing.

12. The method of claim 10 wherein the forming comprises hot pressing and the combining comprises installing a separator in a mold.

13. The method of claim 10 wherein the difference between the first mix design and the second mix design comprises the presence of carbon fiber in the first mix design and not in the second mix design.

14. The method of claim 13 wherein the forming results in the green article having the carbon fibers predominately disposed at one, or both, of the terminal ends of the article as compared to a central portion of the article.

15. The method of claim 10 wherein the forming comprises co-extrusion, the first mix design includes carbon fibers, and the forming includes extruding the first mix design to be disposed on an exterior portion of the article.
